(19) United States
(12) Patent Application Publication
(10) Pub. No.: US 2011/0296922 A1
(43) Pub. Date: Dec. 8, 2011

(54) EMAT FOR INSPECTING THICK-SECTION WELDS AND WELD OVERLAYS DURING THE WELDING PROCESS

(76) Inventor: Syed Mohamed Ali, Lynchburg, VA (US)

(21) Appl. No.: 12/780,866

(22) Filed: Jun. 7, 2010

(51) Int. Cl. G01N 29/04

(52) U.S. Cl. 73/588

(57) ABSTRACT

The invention relates to a method and system for monitoring the integrity of thick section welds during the welding process with electromagnetic acoustic transducers (EMAT). Using induction coils in properly arranged and oriented magnetic fields, EMATs can generate shear horizontally polarized (SH) skimming waves in the base metal adjacent to the weld. A through transmission method is adopted where by a transmitting EMAT is used to generate SH skimming waves on side of the weld while a receiving EMAT is used to sense and assess the ultrasonic signal acquired by a receiver EMAT on the other side of the weld there by indicating the quality of the most recent weld layer applied by the welder.

### BACKGROUND OF THE INVENTION

One of the largest applications of ultrasonic testing (UT) in nondestructive testing (NDT) is weld inspection. The superiority of ultrasonic testing (UT) in detecting certain weld defects over other nondestructive test methods such as radiography has been recognized for many years. For example, narrow cracks that are easily detected by UT can provide such little contrast in a radiograph that the crack would not be detected. Other advantages of UT include, greater inspection speed, lower cost and substantially less hazardous to inspectors.

FIG. 1. Illustrates conventional UT of a thick-section weld. UT is performed primarily by piezoelectric transducers, 1, that generate vertically polarized shear waves (SV-waves) and compression waves (P-Waves). Ultrasonic P-waves propagate through a wedge, 2, to the base metal, 3, adjacent to the weld, 4 and are converted to SV-Waves in the layer of couplant, 5, between the wedge, 2 and the base metal. The SV-Waves are then directed toward the weld and the base metal on the other side, 6, of the base metal and then into the weld, 4. SV-Waves which encounter defects, 7, in the weld, 4, or heat-affected zone, 8, are reflected back to the wedge, 2 and the piezoelectric device, 1, where they are received and converted to an electronic signal.

Inspection techniques vary due to weld material, weld thickness, weld process and even code requirements. Weld inspection by standard ultrasonic methods, e.g., manual contact testing, is usually restricted to joining of plates with thicknesses of 10 mm to 12 mm or more. Scan patterns for manual weld inspection with an ultrasonic transducer are usually zigzag with some overlap to assure full coverage of the weld. Some inspectors rotate the transducers in addition to the zigzag motion to enhance detection of cracks having orientation angles that deviate from normal to the impinging ultrasonic beam. Other inspectors prefer to scan in 3 directions. For example, they scan initially perpendicular to the weld centerline, next at +45° to the weld centerline then −45° to the weld centerline. Scanning speed should be slow enough to maintain coupling and ensure the operator can monitor all events on the CRT.

Inspection with EMATs offers significant advantages over conventional UT. No fluid couplant is required, making EMAT systems much easier to automate and eliminating any need for clean up, a substantial benefit to the nuclear industry where decontamination is mandatory and costly. Since either an adhesive or highly viscous couplant is required to induce the SH waves in the test component structure with piezoelectric transducers, generation of SH waves by conventional UT is not practical. However, EMATs can generate SH waves directly in the structure being tested without any coupling media. Also, EMATs can constructed to withstand elevated temperatures, making it possible to scan the weld immediately after a weld layer is applied. Furthermore, SH EMATs are much more versatile than piezoelectric transducers, since the angle of the SH wave beam is easily changed by adjusting the excitation frequency.

Two electromagnetic phenomenon, magnetostriction and Lorentz force, are used for generation of SH waves with EMATs. Magnetostriction is essentially the expansion and contraction of a ferromagnetic material with application of an alternating magnetic field to the material. FIG. 2 is an illustration of an EMAT that uses magnetostriction to generate SH waves for the inspection of thick-section welds. A meander-line coil, 11, of insulated electrical conductors is placed on the base metal, 3, so that the long conductors are parallel to the centerline of the weld. A magnetic bias field, 13, is applied to base metal in a direction that has a predominant component that is parallel to the to the conductors of the meander-line coil.

When an alternating current is applied to the coil the base metal material, 3, beneath the coil windings, eddy currents that flow parallel to the coil conductors are induced in the base material, 3. The portions of the base material containing and surrounding the eddy currents interacts with magnetic bias field and causes the base material to expand and contract. This produces SH wavelets that propagate away from the conductors in all radial directions within the base metal. Depending on the excitation frequency, the wavelets constructively interfere to produce a bulk wave that propagates from the coil at an angle and angle with respect to the weld. Reflections of the ultrasonic bulk wave from defects return to the same meander-line coil, i.e., transmitter coil, or another coil, not shown, that is placed between the transmitter coil and the weld. The reverse magnetostriction process, also known as the Villari effect, causes an electrical signal response that can be observed at the terminals of the EMAT meander-line coil.

FIG. 3 is an illustration of an EMAT that uses Lorentz forces to generate SH waves for the inspection of thick-section welds. A single loop rectangular coil is placed close to the base metal and under an array of magnets. When an alternating current, 12, is applied to the coil, 9, eddy currents that run parallel to the coil conductors are induced in the base material, 3, beneath the conductors. The eddy currents interact with the magnetic field exiting the poles of the magnets to produce forces on the base material that are parallel to the surface of the base material. This produces SH wavelets that propagate away from the magnet poles in all radial directions within the base metal. Depending on the excitation frequency, the wavelets constructively interfere to produce a bulk wave that propagates from the coil at an angle with respect to the weld. Bulk wave Reflections from defects return to the same EMAT coil that or another coil, not shown, that is placed between the transmitter coil and the weld. The reverse process of electromagnetic generation causes an electrical signal response that can be observed at the terminals of the EMAT meander-line coil.

Significant difficulties are encountered by the conventional UT when applied to inspection during the welding process. The partial weld presents many geometric features that cause reflections and therefore false positive indications of weld defects. The coarse, columnar grain structure of the welds can cause the reflection of the SV-Waves to guide the waves toward the other side, 6, of the base metal producing additional false indications as well as preventing the interrogation of defects in the last weld layer applied. The elevated temperatures of the base metal during and immediately after welding, in many cases prevent the use of any fluid couplant. Manual scanning is tedious and therefore slow, adding to the cost of the welding process.

### SUMMARY OF THE INVENTION

The objective of this invention is to provide a novel and improved UT system and methods for monitoring the integrity of the most recent weld layers applied during the welding process. The system is composed of one or more SH wave EMAT transmitters placed on base material that is attached to either side of the weld. One or more SH wave EMAT receivers are placed on the base metal opposite to and in line with each transmitter. The EMAT transmitters are positioned and oriented so that the SH skimming waves generated by the transmitters will propagate along the surface of the base material, down the machined surfaces, through the most recent weld layer, along the machined surface of the base material and along the top surface of the base material toward the EMAT receiver on the opposite side of the weld. As the EMATs are scanned along the length of the weld, the EMAT receiver detects the SH skimming wave signals and applies them to the system signal processor.

Characteristic features of the received SH skimming wave signals including amplitude, phase and frequency spectra are extracted and applied to computer algorithms. The algorithms automatically decide if a defect is present, classify the defect according to type and estimate critical dimensions of the defect such as depth with respect to the weld surface. The features can also be displayed so that the operator of the welder can interpret the signal feature responses and make the appropriate decisions. Position encoders attached to the scanner provide location of defects and estimates of defect length.

EMAT design parameters including meander coil width, depth, shape and conductor spacing, are selected to provide optimum SH wave length and beam crossection. The operating frequency of the EMAT transmitter is selected to provide the SH skimming wave that adheres as much as possible to the weld surface. The EMAT SH skimming wave weld monitor can be enhanced further by adding a receiver immediately in front of transmitter so that the amplitude of the outgoing signal from the transmitter can be used to normalize the received signal, i.e., divided into the signal detected by the receiver on the other side of the weld. Normalization in this manner automatically adjusts for differences in the received signal amplitude caused by variations in base material properties and variations in the distance between the EMAT and the base plate.

Additional enhancement of the system can be realized by incorporating two transmitter and receiver pairs, on either side on the weld. This configuration provides for two normalized signals that are transmitted through the weld. These signals are applied to a mathematical formula that provides improved normalization and greater accuracy in detection and classification of weld defects. Also, planar defects such as cracks having orientations that deviate from the weld line can be detected by placing the transmitters and receivers so that the SH waves are directed toward the weld line at an angle. Two sets of sensor coil each containing two transmitters and two receivers are oriented approximately 90 degrees with respect to each other and each at approximately 45 degrees with respect to the other. This arrangement assures detection of all defect orientations including those defects that are transverse to the weld.

### BRIEF DESCRIPTION OF DRAWINGS

FIG. 1 is crossection view of conventional ultrasonic inspection of thick-section welds;

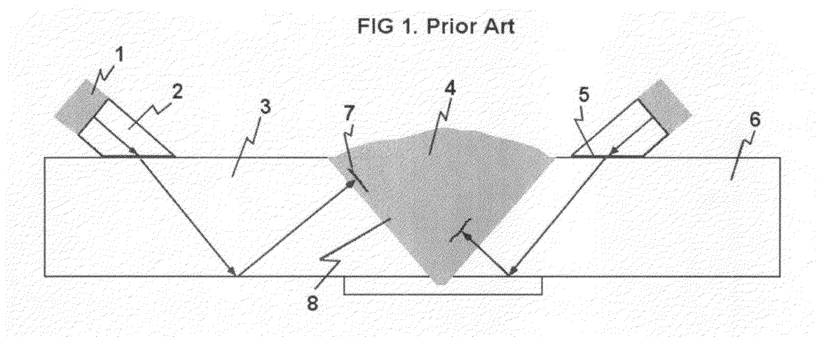

FIG. 2 is a combined crossection view and perspective view of an EMAT for using the magnetostriction of the base metal to generate and detect SH bulk waves reflected from defects in welds.

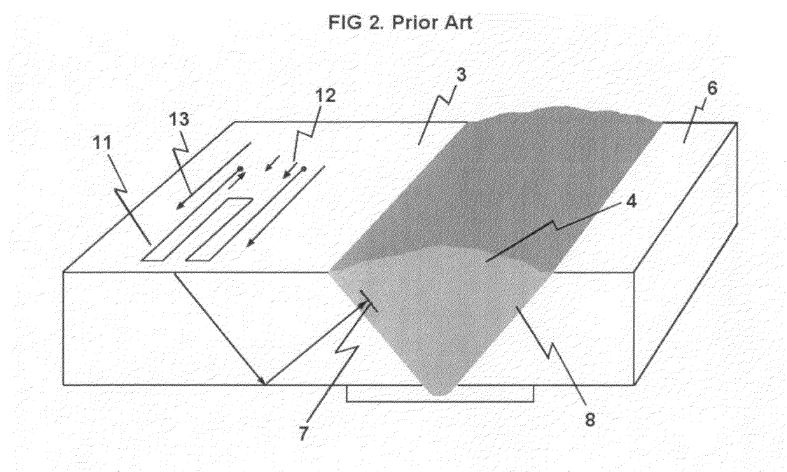

FIG. 3 is a combined crossection view and perspective view of an EMAT for using Lorentz to generate and detect SH bulk waves reflected from defects in welds.

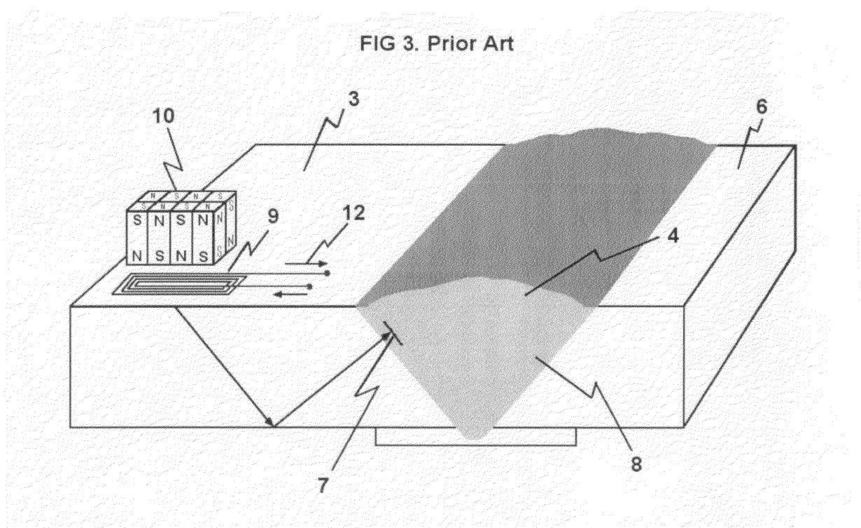

FIG. 4 is a crossection view of an SH skimming wave EMAT inspection of a weld in process;

FIG. 5 is a crossection view of an SH skimming wave EMAT inspection of a weld overlay in process;

FIG. 6 illustrates a top and crossection view of an SH Skimming Wave EMAT arrangement of one transmitter and two receivers for inspection of a weld in process;

FIG. 7 illustrates a top view of an SH Skimming Wave EMAT arrangement of two transmitters and two receivers for inspection of a weld in process;

FIG. 8 illustrates a top view of an SH Skimming Wave EMAT arrangement of four transmitters and four receivers for inspection of a weld in process;

FIG. 9 Illustrates of a top view of a magnetostriction EMAT arrangement of curved meander-line transmitter coils and narrow meander-line receiver coils;

FIG. 10 Illustrates of a top view of a Lorentz EMAT arrangement containing an arrangement of permanent magnets placed over rectangular transmitter coils and narrow magnet arrays placed over two receiver coils;

### DETAILED DESCRIPTION OF DRAWINGS

The invention described in this patent pertains to, EMAT sensor arrangements and technique for automatic inspection of thick-section welds during the welding process. Thick-section welding can be defined as the joining of two plates or sections of pipe that have a thickness greater than 12 millimeters. Since most thick-section welds are fabricated by the application of a series layers using processes such as submerged arc welding, substantial savings of labor and materials can be realized by rapidly inspecting the weld immediately after each layer of weld is applied. This is especially true of welding in irradiated environments such as in nuclear reactors where the costs of labor and handling of materials are very high. In this environment it is of great value to have an automated inspection that is fast and requires little or no preparation of the weld.

EMATs are used with electronic instrumentation to transmit SH waves through the weld and to receive the waves on the other side. The EMAT transmitter and receiver designs along with the operating parameters of the instrumentation are optimized so that the SH waves are concentrated in a region that is close to the surface of the weld. Changes in characteristics such as amplitude and frequency content of the signals detected by the EMAT receiver are indications of defects in the latest layer applied to the weld. This allows for the immediate repair of the weld prior to completion of the weld when the cost of repair is substantially greater.

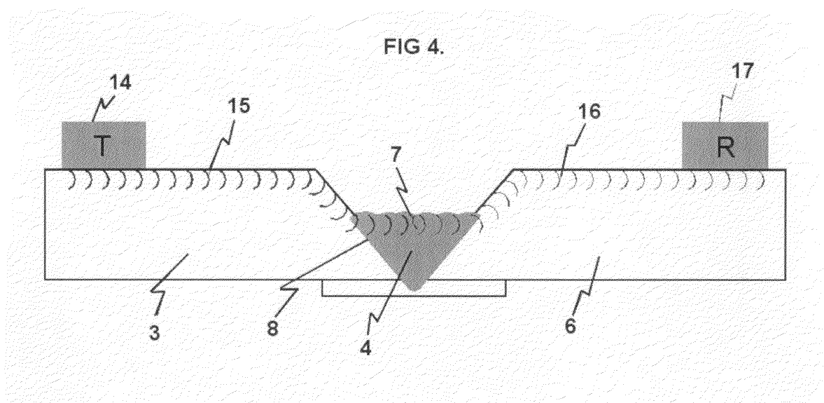

FIG. 4 is a crossection view of an SH skimming wave EMAT inspection of a weld in process. The transmitter, 14, generates SH skimming waves by either magnetostriction or by Lorentz forces which concentrate the acoustic wave within a few millimeters of the base metal surface where the transmitter is located. This is accomplished by adjusting the center frequency of the tone burst emitting from the excitation power source. The frequency required to generate the skimming wave is typically several Hz lower than the frequencies required for generation of SH bulk waves in the base metal. Optimization of the skimming wave generation is typically accomplished by decreasing the excitation frequency to the point where secondary bulk wave lobes begin to appear. The excitation frequency is then increased slightly to assure that the secondary lobes do not occur during an inspection scan of the weld.

The SH skimming wave, 15, generated by the EMAT transmitter, 14, travels in the base material, 3, toward the weld, 4. The Said wave continues to propagate along the machined contour of the base metal and into the partially fabricated weld, 4. A relatively high percentage of its energy is concentrated near the said base material and weld. Unimpeded by the absence of any imperfections near the weld surface, a part of said SH Skimming wave, 16, not scattered by the weld microstructure, propagates through the weld and into the base metal, 6, on the other side of said weld. Part of said wave is then intercepted and detected by receiver EMAT, 17. If there are no defects in the most recent weld layer, an electrical signal of nearly maximum amplitude will be observed at the terminals of the receiver sensor coil.

When the transmitted SH Skimming wave, 15, encounters a defect, 7, such as a crack near the surface of the said weld, part of the said wave is scattered such that a lesser part of the said wave propagates on to be intercepted by the receiver, 17. This results in a decrease in the amplitude of the signal that is observed at the terminals of said receiver. Since the frequency content of the said transmitted wave is typically a spectrum of frequencies that can be observed within a band as determined by the waveform of the transmitter electrical excitation and design of said transmitter EMAT, some defects near the surface of the weld can cause a change in the shape of the frequency spectrum. These said changes in the frequency spectrum can be measured in near real time by computer algorithms including Fast-Fourier Transforms (FFT) and digital band pass filters. These measurements can then be applied to computer decision functions and classification algorithms to detect and characterize defects that occur in said weld. A number of analog, band-pass filters can be used in a similar manner to provide the same function. This automated process enables a rapid and efficient detection, location and characterization of defects in the most recently applied weld layer.

Weld cladding is a recognized means of depositing a metallic on to a structure to enhance its properties such as strength and resistance to corrosion. An important application in the nuclear industry is the weld overlay cladding on a weld that has experienced stress corrosion cracking (SCC). The cladding serves to strengthen the weld and relieve the stress so that SCC is inhibited. The use of the subject patent to monitor the integrity of subsequent applications of layers of weld overlay cladding would be of substantial benefit in reducing the costs of labor and material associated that are associated with conventional UT.

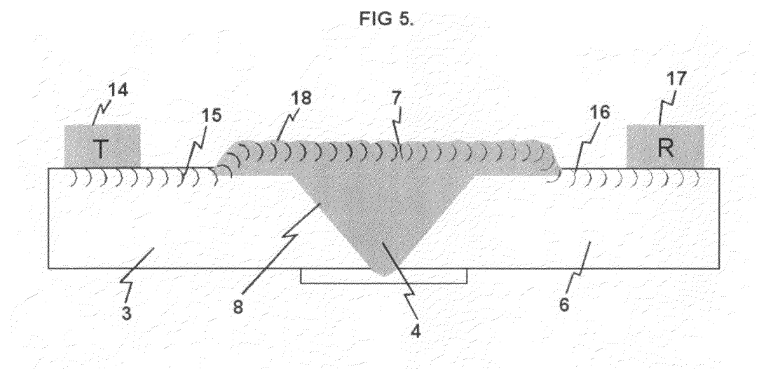

FIG. 5 is a crossection view of an SH skimming wave EMAT inspection of a weld overlay cladding in process. The transmitter, 14, generates SH skimming waves by either magnetostriction or by Lorentz forces which concentrate the acoustic wave within a few mm of the base metal surface where the transmitter is located. The SH skimming wave, 15, generated by the EMAT transmitter, 14, travels in the base material, 3, toward the weld, 4. The Said wave continues to propagate toward the heat affected zone, 8, of the original weld and into the clad overlay, 18. Unimpeded by the absence of any imperfections near the weld surface, a part of said SH Skimming wave, 16, not scattered by the weld overlay microstructure, propagates through the weld and into the base metal, 6, on the other side of said weld overlay. Part of said wave is then intercepted and detected by receiver EMAT, 17. This results in an electrical signal of nearly maximum amplitude to be observed at the terminals of the receiver sensor coil. Signal processing identical to that described in paragraph [ ] can be applied to detect, classify and estimate the dimensions of defects in the last layer of cladding.

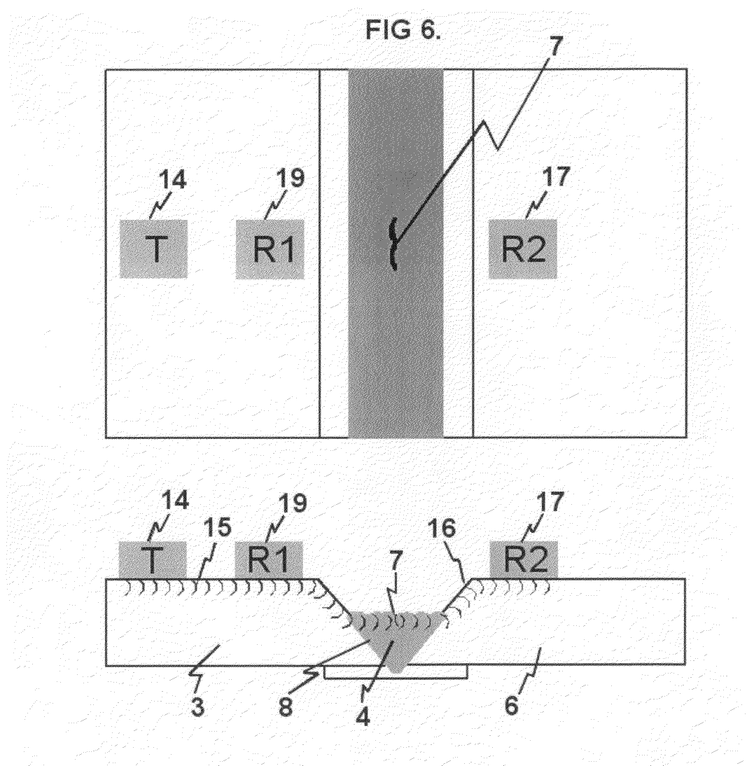

Improvement in the SH skimming wave weld monitor can be accomplished by adding another receiver immediately in front of the transmitter. FIG. 6 illustrates top and crossection views this sensor arrangement having a single transmitter and two receivers. The SH skimming wave propagating from transmitter, 14, passes under receiver, 19, before entering the surface of the weld, 4. The signal response to said skimming wave provides an indication of the effects of variations in material properties and proximity of the EMATs to the base material, 3, on the amplitude of said transmitted skimming wave. Compensation for the affect that these signal variations have on the amplitude of the signal response acquired by the receiver, 17, on the other side of the weld can be accomplished by dividing said receiver, 17, signal response by the signal response of receiver, 18 as indicated by the mathematical formula described in EQ. 1.

SN2=A2/A1 EQ. 1

### Where,

SN2 is the normalized signal from receiver R2, 17, and
A2 is the signal from said receiver R2 and
A1 is the signal from receiver R1, 19.

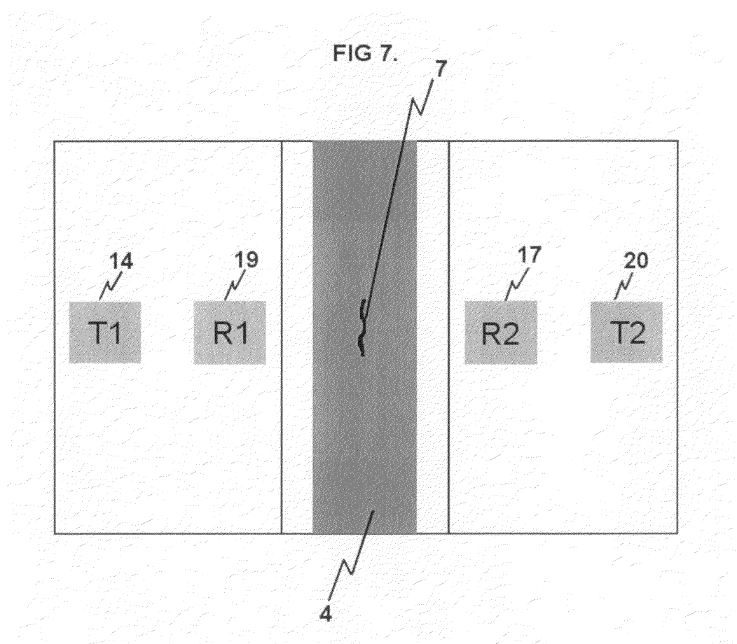

Further improvement in the SH Skimming wave weld monitor can be realized by adding a second transmitter as well as a second receiver as illustrated in FIG. 7. Transmitters, T1, 14, and T2, 19, are fired simultaneously. Then receivers, R1, 19, and R2, 17, provide signals having amplitudes A11 and A22 respectively as the SH skimming waves pass under said receivers toward the weld, 4. After passing through the weld said SH skimming waves arrive under receivers R1, 19 and R2, 17, to generate signals having amplitudes A21 and A12 respectively. These four said signals are then applied to mathematical formulas such as described in EQ. 2. to compensate for material variations and liftoff of any or all of the EMATs. Also, this EMAT arrangement provides for improved probability of defect detection and accuracy in characterization by interrogating the weld from base metal on two sides.

SNT=SQRT(A12/A11×A21/A22)

### Where,

SQRT is the square root operator,
A12 is the signal transmitted from T1 and observed at receiver R2 and
A21 is the signal transmitted from T2 and observed at receiver R1 and
A11 is the signal transmitted from T1 and observed at receiver R1 and
A22 is the signal transmitted from T2 and observed at receiver R2 and

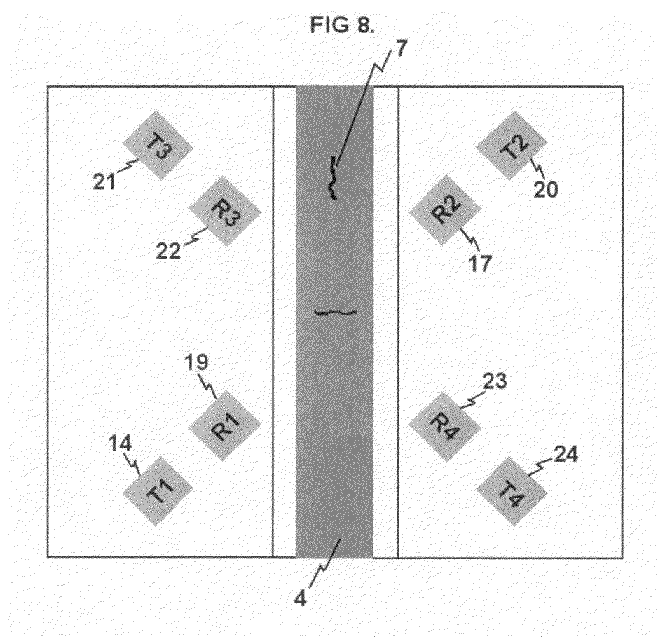

Detection of defects having various shapes and all orientations including cracks that are transverse to the weld line can be improved by using four transmitters and four receivers as illustrated in FIG. 8. Transmitters T1, 14, and T2, 20 are paired with receivers R1, 19, and R2, 17, to form a line of SH wave EMATs that is approximately 45 degrees with respect to the weld line. Additional transmitters T3, 21, and T4, 24 are paired with receivers R3, 22, and R4, 23, to form a line of SH wave EMATs that is approximately 90 degrees with respect to the said line of EMATs composed of transmitters T1, T2, R1 and R2.

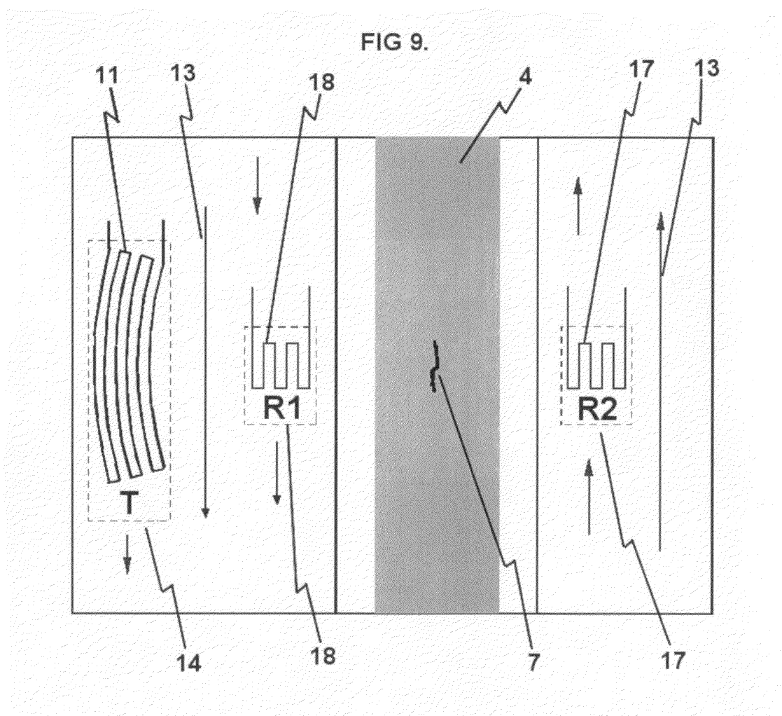

Sensitivity and resolution of the said lines of EMATs can be improved by using wide, focused transmitters and narrow receivers as illustrated in FIG. 9. Taking the distance from the weld and the excitation frequency into account the transmitter coil, 11, is designed so that SH skimming wave beam profile in the plane at the weld surface is minimized in width. As a result, small defects, 7, in the weld intercept a greater percentage of said SH skimming wave and the decrease in the amplitude of the signal response is a greater percentage of the maximum signal received when there no defects in that pate of the weld. Also, a decrease in the width of receiver R2, 17, provides greater decrease in the received signal amplitude when said defect in the weld intercepts said SH skimming wave. The combined effect of said modifications in said EMATs is a more abrupt and greater decrease in said signal response to a said defect inn said weld thus providing greater sensitivity in detecting small defects in the weld and greater accuracy in determining the position and length of said defects.

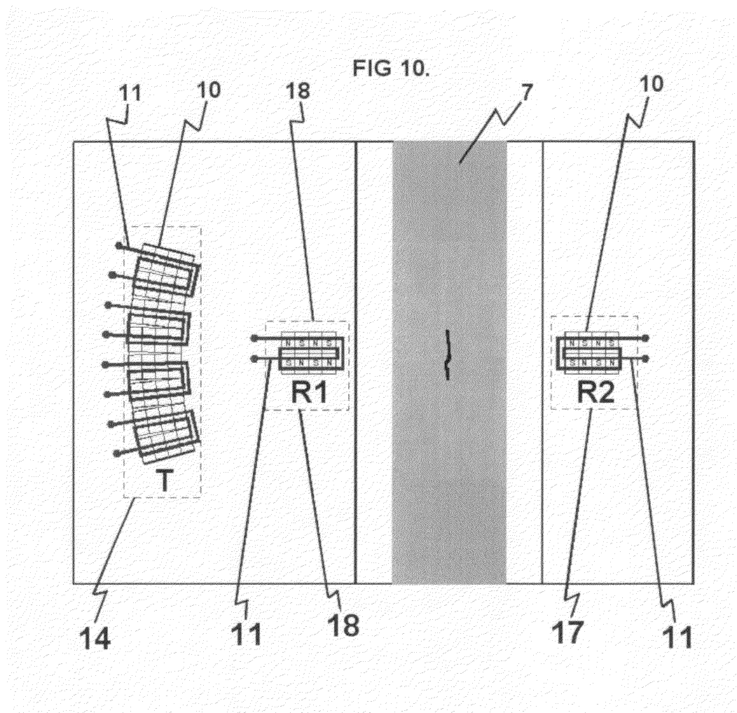

While FIG. 9 illustrates the focused transmitter and narrow receiver EMAT design using the magnetostriction principle, GIG. 10 illustrates said EMAT design using the Lorenz force principle. Referring to FIG. 10, focusing the transmitted beam of skimming SH waves is accomplished by the assembly of a curved array of permanent magnets, 10. Placement of coils, 11 under each segment of said magnet array, forms the focused transmitter EMAT, 11.

Said coils can be excited by bursts of alternating current by one or more RF power sources. Said coils can be provided with excitation current by separate RF power sources to produce an SH skimming wave of maximum intensity. When said coils are to be excited by one said power source, they are connected in series. Likewise pairs of said coils can be connected in series and each pair fired by separate RF power sources.

1. A method of using SH EMATs whereby the EMAT design parameters such as meander coil size, conductor spacing, conductor angle, magnet array size, spacing and shape and EMAT system instrumentation operating parameters such as excitation frequency, magnetic bias field and the position of the EMAT with respect to the weld are optimized to generate, detect and measure SH skimming waves to monitor the integrity of thick section welds during the welding process.

2. A method as in claim 1 where a transmitting EMAT and two receiving EMATs are arranged as illustrated in FIG. 6. so that receiver EMAT,2, measures the intensity of outgoing SH wave from transmitter,1, and receiver EMAT,4, measures the intensity of the SH wave after said SH waves have been effected by defects in the weld thereby providing a means, according to EQ. 1, of predicting the occurrence of defects while providing partial compensation for variations in amplitude of the SH wave caused by variables such as base plate electromagnetic characteristics and proximity of the EMATs to the base plate material.

3. A method as in claim 1 where two transmitting EMATs and two receiving EMATs are arranged as illustrated in FIG. 7. so that receivers EMAT,2 and 4, respectively measure the intensity of outgoing SH wave from transmitters,1 and 3, respectively and receivers EMAT,2 and 4, measures the intensity of the SH wave after said SH waves have been effected by defects in the weld thereby providing a means, according to EQ. 2, of predicting the occurrence of defects while providing partial compensation for variations in amplitude of the SH wave caused by variables such as base plate electromagnetic characteristics and proximity of the EMATs to the base plate material.

4. A method as in claim 1 where sets of EMATs, each set having two transmitting EMATs and two receiving EMATs are arranged as illustrated in FIG. 8 so that each set is aligned to generate SH skimming waves that intercept the weld line at an angle between 30 and 60 degrees and that said SH skimming waves of each set of EMATs propagate at an angle between 30 to 60 degrees with respect to each other thus providing detection of all defect orientations with nearly equal sensitivity.

5. An EMAT design as in claim 1 and Illustrated in FIG. 9. composed of meander coils of insulated electrical conductors having optimum length and shape, all acting in a magnetic bias field for the purpose of generating SH skimming waves by magnetostriction within the base meterial and focusing said waves in the horizontal plane in the weld layer to provide improved, uniform sensitivity to defects over the weld width and greater resolution and accuracy in locating and measuring the length of defects.

6. An EMAT design as in claim 1 and Illustrated in FIG. 10. composed of arrays of magnets of optimum dimensions placed over and in close proximity to meander coils of insulated electrical conductors having straight sections arranged in an angular array for the purpose of generating SH skimming waves by Lorentz forces and focusing the SH skimming wave in the horizontal plane in the weld pass to provide improved, uniform sensitivity to defects over the weld width and finer resolution in locating and measuring the length of defects.

7. An EMAT design as in claim 1 where the conductor spacing of said meander coils are selected to provide maximum concentration of SH waves near the surface of the weld while providing a minimum attenuation of the SH waves by the surface roughness of the weld.

8. An EMAT design as in claim 1 where the geometry and spacing of the magnets in the magnet array selected to provide maximum concentration of SH waves near the surface of the weld while providing a minimum attenuation of the SH waves by surface roughness of the weld.

9. Selection or the EMAT system instrumentation operating frequency as in claim 1 to provide maximum concentration of SH waves near the surface of the weld while providing a minimum attenuation of the SH waves by the surface roughness of the weld.

10. Selection of the angle of the magnetic bias as in claim 1 within 0 degrees to 60 degrees with respect to the direction of the SH wave travel to provide maximum concentration of SH waves near the surface of the weld while providing a minimum attenuation of the SH waves by the surface roughness of the weld.
